(19) United States
(12) Patent Application Publication
(10) Pub. No.: US 2016/0143478 A1
(43) Pub. Date: May 26, 2016

(54) GRILLING DEVICE, IN PARTICULAR BOWL GRILL

(71) Applicants: Thomas KAISER, Schrattenbach (DE); Christian WASSERMANN, Kraftisried (DE)

(72) Inventors: Thomas KAISER, Schrattenbach (DE); Christian WASSERMANN, Kraftisried (DE)

(21) Appl. No.: 14/784,989

(22) PCT Filed: Apr. 15, 2014
(86) PCT No.: PCT/EP2014/000999

§ 371 Date: Feb. 10, 2016

(30) Foreign Application Priority Data
Apr. 16, 2013 (DE) 20 2013 003 540.4

(51) Int. Cl. A47J 37/07

(52) U.S. Cl. CPC A47J 37/0763

(57) ABSTRACT

The aim of the invention is a variable heat regulation and a comfortable operation of a grilling device, in particular in the form of a bowl grill (1), comprising a lower shell (4) in which a heating plane and a grill grate are arranged, the vertical spacing between the grill grate (5) and the heating plane being variable. This is achieved in that the spacing between the grill grate (5) and the heating plane can be adjusted by a coupling mechanism which is arranged within the lower shell (4) in particular. The coupling mechanism is preferably designed as a flat parallelogram mechanism or scissor mechanism and can be adjusted by pivoting the lower shell (4).

The invention relates to a grilling device, especially a bowl grill according to the preamble of claim 1.

Such grillers are widespread, particularly as a spherical grill for grilling food over a heat source, preferably charcoal or barbecue briquettes of wood. The adjustable distance of the charcoal is of particular importance for the barbecued food. Is the food to be grilled too far away, this is not sufficiently cooked. On the other hand, if the food is too close to the charcoal, the food might be inedible. To change the distance between the food and heating source in a variable way, conventional grills have staggered slots into which the grill is hooked or plugged, accordingly. A disadvantage is that the outer surface must remain open so that the griller has sufficient airflow to be operated efficiently. In addition, there is a risk of tipping to the grill when it is removed from the slots to be then introduced into higher or deeper slots to change the distance. This is dangerous and often feasible only with gloves, with the risk that the operator drops the grilled food or burns it.

DE 197 17 450 describes a griller, wherein the distance between the heat source (for example, charcoal, gas burner or electric heating coil) and the food can be changed by a rotatable screen. This is not applicable to a bowl grill or to a barbecue in horizontal cylinder form. In addition, the projecting handle of the grill grate forms a risk of accidents, e. g. for burns as the grill can have high temperatures. In addition, the adjustment of the distance between the food to be grilled and the heating means requires a relatively large effort. The same applies to barbecues with detachable hoods, being inconvenient and possibly dangerous for the operator.

Thus, the object of the present invention is to overcome the aforementioned disadvantages of known devices and to provide a barbecue grill, which allows a variable heat regulation in comfortable and safe manner. In addition, a practical operation with good ventilation should be ensured.

This task is solved by a grilling device having the features of claim 1 or 5. Preferred embodiments are subject of the dependent claims.

The grilling device according to the invention, in particular in the form of a bowl grill, wherein the vertical distance between food and heating plane is variable, has a lower shell, which is preferably pivotably mounted on the frame about a horizontal axis, wherein the distance between the grill grate and heating plane is adjustable by a coupling mechanism. The coupling gear (also referred to as a planar transmission), forms a coupling linkage, in particular in parallelogram or scissors form and can be installed within the lower shell in space-saving manner. In this case, a rod member may be guided in a guiding nut.

Preferably, at least one air opening is provided in the bottom region of the lower shell, in particular in a slot form that can be continued up to upper shell of a spherical grill. It is of independent importance that a horizontal axis for pivoting the lower shell is preferably formed by two bearing lugs or “eyes” on the frame, which can also be designed as a relatively low tabletop grill. These bearing lugs and the lower shell and upper shell can be clamped and fixed, wherein the pivoting movement is carried out in particular under application of a spring assembly, so that the upper and lower shell is held securely in each pivot position. The height adjustment of the heating plane also regulates the airflow, resulting in a comfortable and safe heat control in all positions (open, half open, closed).

The heat source of the griller is in particular charcoal, which is located at the heating plane and has an ash trough of approximately equal area. The ash dump is preferably formed as a drawer to be removed from the lower shell and the heating plane, so that the disposal of ash is particularly easy. A tray may be hooked to the side of the grill for preparing food, wherein the bearing lug can be employed. Of course, such shelves or trays might be positioned on both sides or bearing eyes of the barbecue grill.

The linkage can be centrally fixed in a simple manner at the bearing eyes, in particular with a screw at the pivot axis, so that a simple and space-saving assembly is achieved. For easy operation of the griller a so-called charcoal starter can be put on the heating plane for starting the fire. This improves starting of the grill in conjunction with better ventilation without the risk that coal is falling out of the grill. Thus, the reliability of the griller is increased, and such a closed combustion chamber provides optimal airflows. Further, the spherical shape of the components improves the grill operation, so that food to be grilled can be directly heated and/or indirectly and thus optimally cooked.

Subsequently, preferred embodiments of the inventive grilling device (also referred to as grill) are described in more detail with reference to the drawings. The drawings show in:

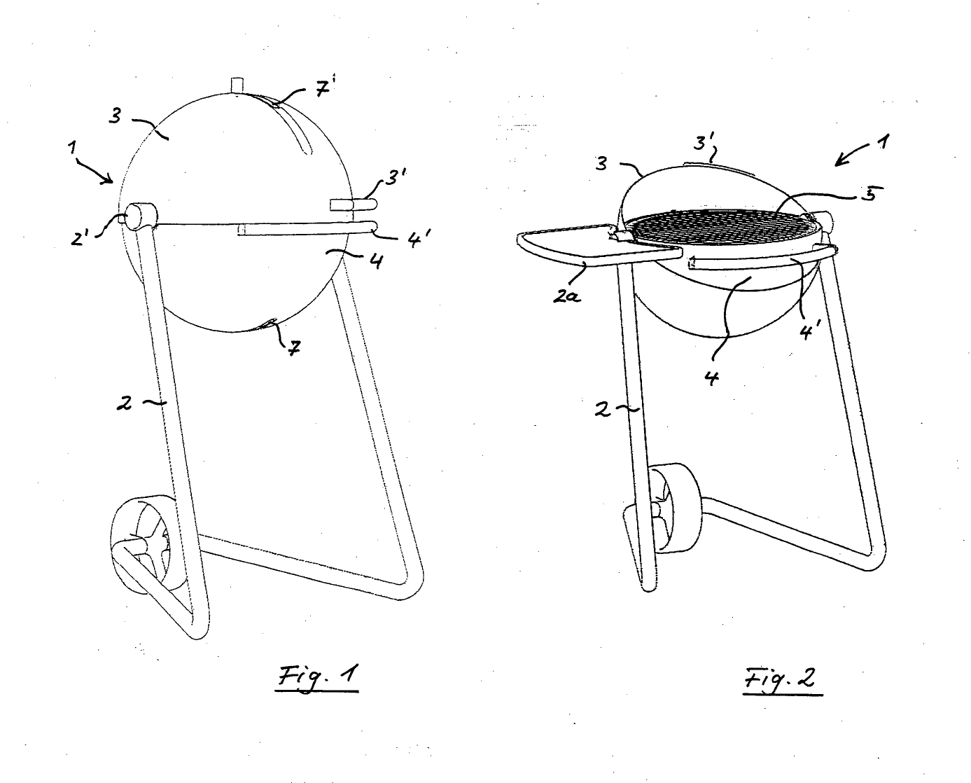

FIG. 1 a grill in closed, perspective view,

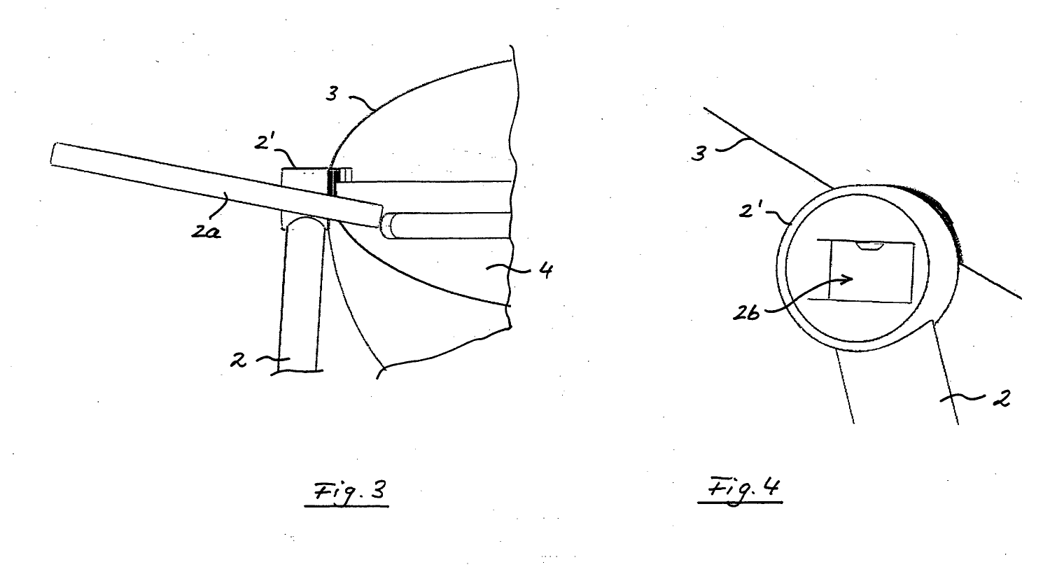

FIG. 2 a perspective view with open topside of the grill,

FIG. 3 a partial view of FIG. 2 for attaching a griller tray,

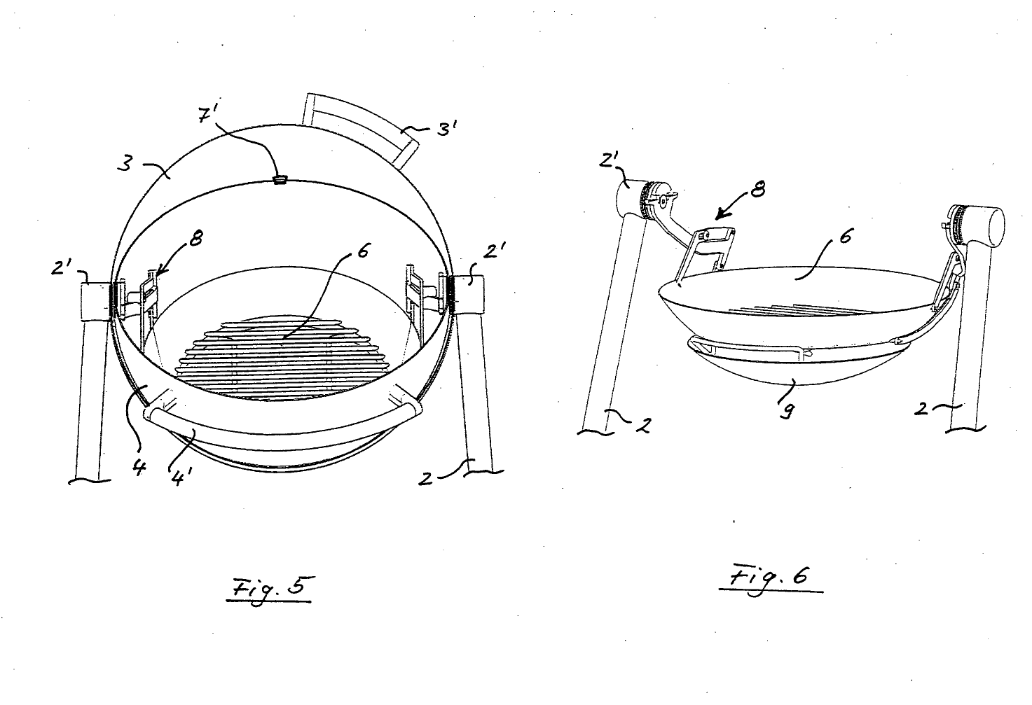

FIG. 4 a detailed view of a bearing eye of the grill,

FIG. 5 a view in the grill inside (without grill grate)

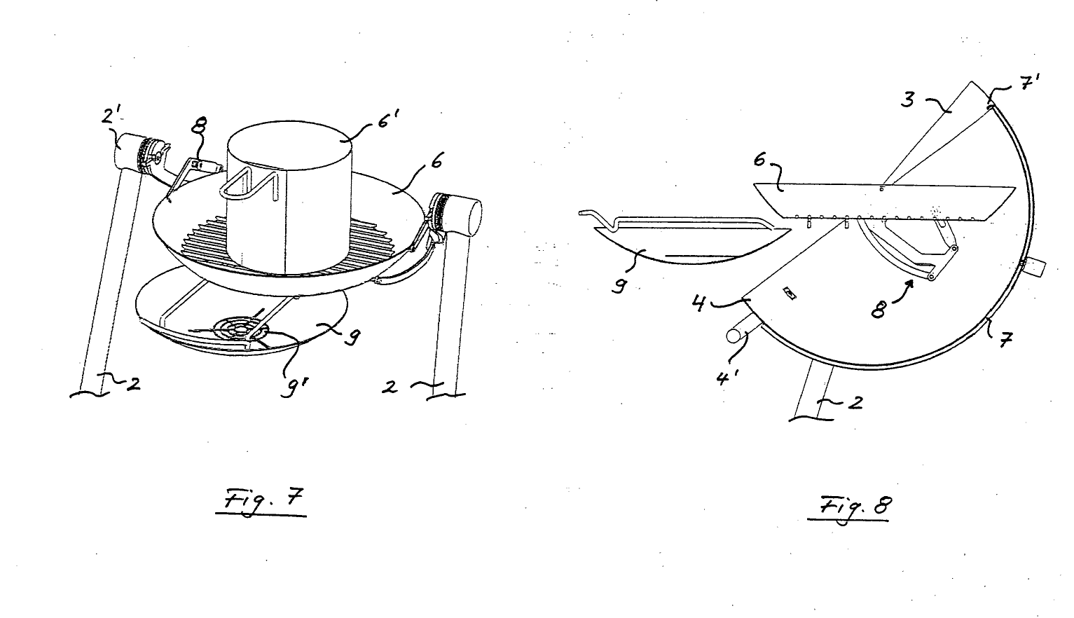

FIG. 6 a perspective view of internal parts (without the upper and lower shell)

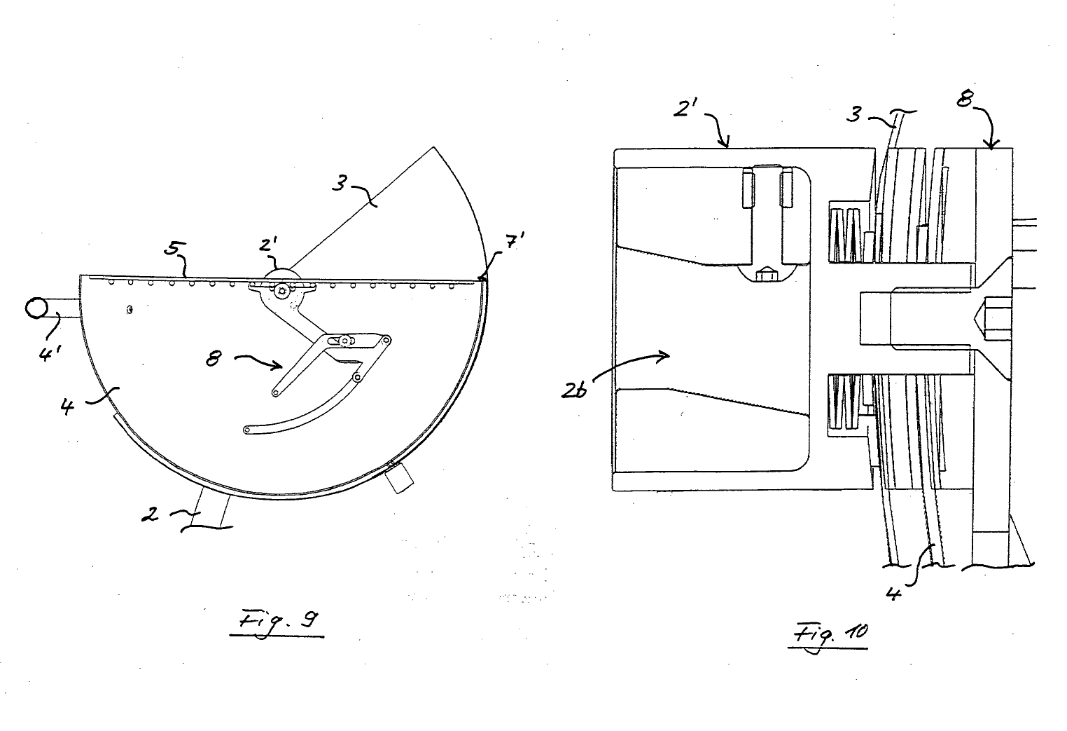

FIG. 7 a perspective view of a charcoal starter,

FIG. 8 a side sectional view of an ash trough,

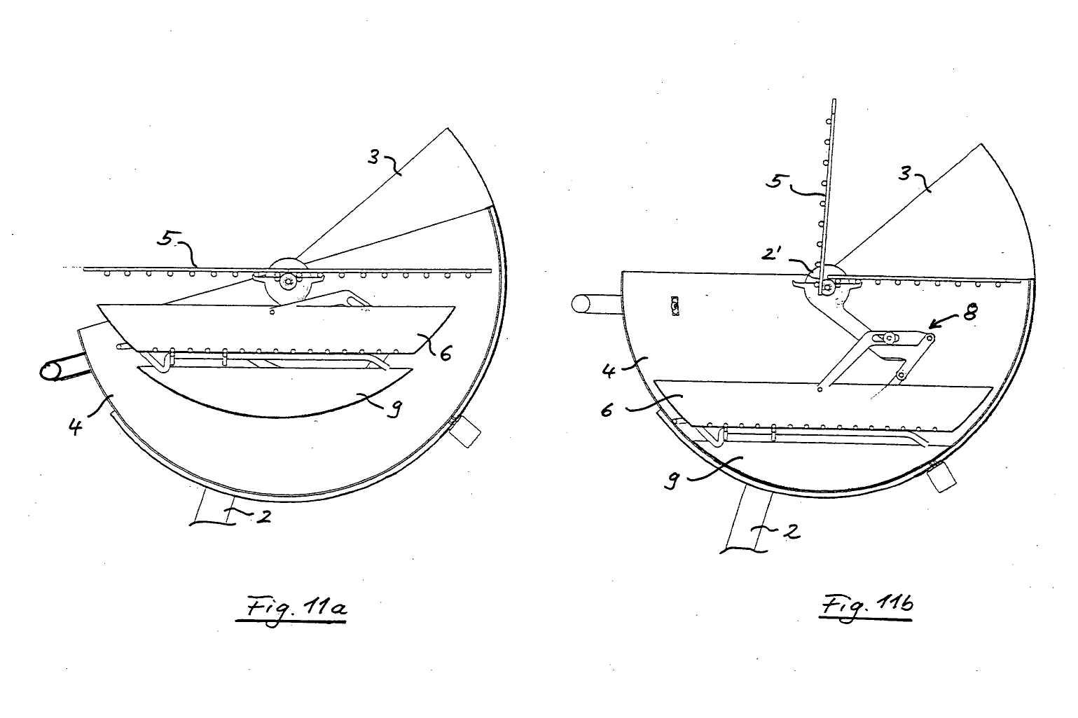

FIG. 9 a similar view as in FIG. 8, but without heating and ash trough,

FIG. 10 a detailed structural view of a bearing eye (lug),

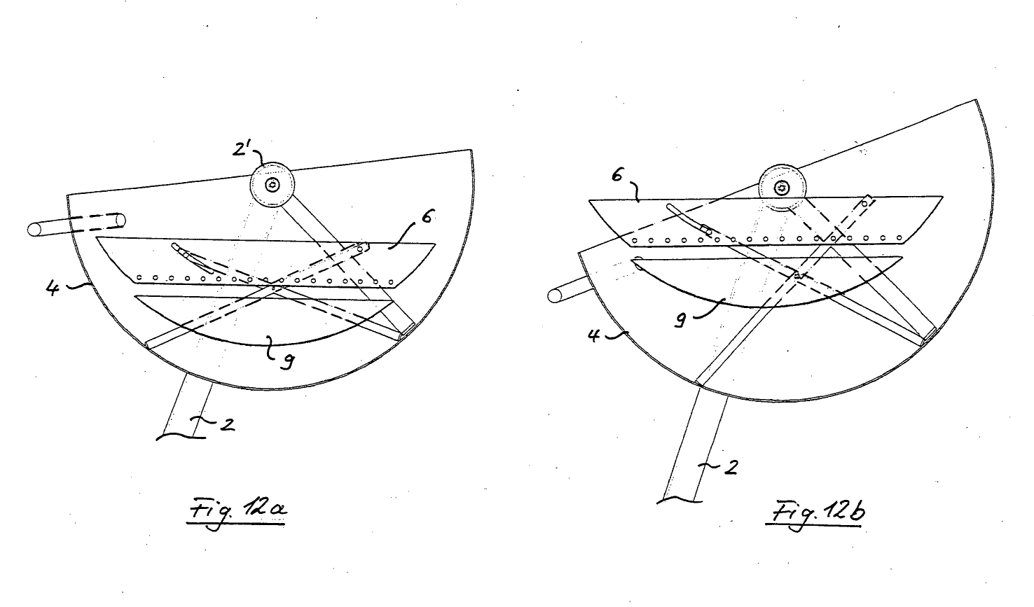

FIG. 11 two views with raised or lowered heating level, and

FIG. 12 similar views as in FIG. 11, but with a scissor linkage.

The illustrated grilling device 1 is a so-called sphere or bowl grill, which has a frame 2 for easy transportation in the garden or on the terrace by an integrated wheel. When operating the grill in open-air charcoal is preferably used as fuel. The bowl grill 1 has a lid (also forming a weather and wind screen) as an upper shell 3 and a lower shell part 4, which encloses the heating source safely. Preferably, the upper shell 3 and the lower shell 4 are each formed as ball halves. The bowl grill 1 can be opened, as shown in FIG. 2, but also operated with a closed housing, as shown in FIG. 1, as well as in all intermediate positions. In particular for cooking of meat, relatively long cooking times required. For pivoting the upper shell 3 (around the bearing eyes 2′ forming a horizontal axis), a handle 3′ is provided, as well as a wider handle 4′ at the lower shell 4. In the closed state, air flows through corresponding air openings 7, which are preferably slot-shaped. The handle 3′ is preferably mounted eccentrically, for gripping aside of the heat source.

In FIG. 2 a grill grate 5 for the barbecued food can be seen when the upper shell 3 is opened. The food can be prepared on a lateral shelf 2a (often referred to as a tray). This tray 2a can be inserted laterally into the bearing eye 2′, as shown in FIG. 3, and be locked in the horizontal position. For this purpose, an opening 2b in the bearing eye 2′ is provided with a hook, as shown in FIG. 4.

FIG. 5 shows a view of a heating plane 6 arranged in the lower shell 4, wherein the grill grate 5 is here removed. To adjust the (vertical) distance between grill grate 5 and heating plane 6 a coupling mechanism 8 is provided, which is described in more detail below. This coupling linkage or mechanism 8 fixed to the bearing lugs or eyes 2′ is used for pivoting of the lower shell 4 around horizontal axis of the bearing eyes 2′ to adjust the distance between grill grate 5 and heating plane 6. This arrangement is of particular importance here, since this allows a particularly stable construction and safe operation, although it is basically also possible to operate the coupling mechanism 8 via a lever or knob located outside of the lower shell 4.

As shown in FIG. 6 (without surrounding components), the coupling mechanism 8 is configured as a linkage, in particular in a parallelogram (see FIG. 11, as well) or scissor-shape, as shown in FIG. 12 in two lifting positions. The coupling mechanism 8 is articulated to the bearing lugs 2′, as well as to the heating level 6, under which an ash trough 9 is provided, when the grill is fired with charcoal.

For this preferred “heating source” of the barbecue device 1, a charcoal starter 6′ is placed on the heating level or plane 6, as shown in FIG. 7, to ease the start-up of grilling. This charcoal starter is open downwards and promotes glowing through the coal. In addition, the development of sparks is reduced, thus promoting the safety and convenient operation. This also applies to the ash trough 9, which has a firing surface 9′ for cooperation with the charcoal starter 6′ and can be pulled out like a drawer from the underside of the heating plane 6, so as to be then taken out from the lower shell 4, as shown in FIG. 8. Here, the air opening 7 is also shown, which can be changed with a slider in cross section to control the ventilation. At the upper end the slider has a radially inwardly directed catch or hook to tightly fit with the “flap” of the upper shell 3 at the top of the lower shell (cf. FIGS. 5 and 9), such that the lower slot stays open. This arrangement provides the air opening 7 in the bottom region of the lower shell 4 (and the top shell 3) for obtaining a continuous airflow in the bowl grill 1.

In FIG. 9, a portion of the linkage 8 is depicted without adjacent components. The free ends of coupling rods can be attached to the heating level 6, so that it is adjusted in exact horizontal position (cf. FIG. 11, as well).

FIG. 10 shows one of the two bearing lugs 2′ forming the horizontal axis. Here, the lower shell 4 and the upper shell 3 are clamped under application of a flat spring assembly and optionally a friction lining, so that the upper and lower shells 3, 4 can be pivoted independently of each other and remain in its respective pivotal position. In addition, the central portion of the coupling linkage 8 is centrally to this bearing eye 2′, in particular with a hexagon socket screw along the pivot axis.

FIG. 11 is divided into two sub-figures to illustrate the distance adjustment between grill grate 5 and the heating plane 6. In FIG. 11a, the distance is relatively low, while in FIG. 11b the mutual distance is at a maximum, i.e. the heating level 6 and the ash trough 9 are located in the lowest position. In this position the lower shell 4 is tilted up, while in FIG. 11a, the lower shell 4 is pivoted around 30° swing angle (about the horizontal axis of the bearing eyes 2′) by depressing the handle 4. Thus, the coupling mechanism 8 is pivoted, as well, such that the attached heating level 6 moves up towards the grill grate 5, whereas FIG. 11b shows these components in distanced position (here a half of the grate 5 is opened-up). The double articulation at the free ends of the linkage 8, keeps the heating level 6 exactly in horizontal position.

This also applies for the alternative embodiment shown in FIG. 12, wherein a projecting arm is used as a coupling transmission 8. FIG. 12a shows a lowered position and FIG. 12b is a raised position, which is variable via pivoting of the lower shell 4. Here, the ash trough 9 is also raised and lowered, which is adapted to the shape of the bowl grill 1. The ash trough 9 may be formed from a thin-walled sheet metal or heat-resistant material. In the maximum lowered position (cf. FIG. 11b, as well) the supply of air towards the interior of the sphere grill 1 is relatively low, since this corresponds to the minimum heat requirement. If, however, more heat is required for the barbecue food the lower shell 4 is pivoted or swung upwards (raised), such that the heating level 6 and the ash trough 9 is raised, and in accordance therewith the air supply is improved by this intuitive regulation.

To sum up, this grilling device allows easy and accurate adjustment of the distance between grill grate and heating plane, thus achieving a gentle and uniform grilling effect. In particular, sensitive barbecuing can be achieved by using ceramic discs at the grill grate 5. In this way the grilled food is not directly heated by the charcoal, but by thermal radiation in the bowl grill 1 (indirect grilling). Further, the operation is greatly facilitated by the firing surface 9′ in the ash trough 9 and the charcoal starter 6′, which can be easily stored by the low height. This also applies for the barbecue grill 1.

### LIST OF REFERENCE NUMBERS

1 grilling device
2 frame; 2′ bearing eye; 2a tray
3 upper shell (with handle 3′).
4 lower shell (with handle 4′)
5 grill grate
6 heating plane (coal grate); 6′ firing chimney
7 air opening (with hook 7′ for air slider)
8 linkage mechanism
9 ash trough (with firing surface 9′)

1. Grilling device, in particular bowl grill, comprising:
a lower shell in which a heating plane and a grill grate are located,
wherein the vertical distance between grill grate and heating plane is variable, and
wherein the distance between the grill grate and the heating plane is adjustable via a coupling mechanism, which is especially arranged inside the lower shell.

2. Grilling device according to claim 1, wherein the coupling mechanism is designed as a linkage, in particular in parallelogram or scissors form, wherein the coupling mechanism is especially adjustable via pivoting of the lower shell.

3. Grilling device according to claim 1, wherein at least one air opening is provided in the bottom region of the lower shell, in particular in the form of a slot.

4. Grilling device according to claim 1, wherein one air opening, in particular in slot form, is provided in the lower shell covered by an upper shell, wherein an air slide is provided with a hook which rests on an upper edge of the lower shell.

5. Grilling device according to claim 1, wherein at least the lower shell is pivotally mounted on a frame, in particular in two bearing lugs of the frame.

6. Grilling device according to claim 5, wherein at least one of the lower shell and an upper shell are supported at the bearing lugs, especially clamped under application of a spring package.

7. Grilling device according to claim 1, wherein an ash trough is arranged below the heating plane and formed as coal grate having approximately an equal area.

8. Grilling device according to claim 7, wherein the ash trough is removable from the lower shell.

9. Grilling device according to claim 7, wherein the ash trough below the heating plane is guided in a drawer-like manner and has preferably a striking surface.

10. Grilling device according to claim 5, wherein at least one storage tray can be suspended at the bearing lug.

11. Grilling device according to claim 5, wherein the coupling mechanism is centrally fixed at the bearing lug, in particular by a central screw on the pivot axis.

12. Grilling device according to claim 1, wherein a charcoal starter is placed on the heating plane for heating-up.

13. Grilling device according to claim 1, wherein the coupling mechanism is to be actuated by a separate operating element, especially by a lever or knob outside of the lower shell.
